(19) United States
(12) Patent Application Publication
(10) Pub. No.: US 2025/0166366 A1
(43) Pub. Date: May 22, 2025

(54) SCENE TOKENIZATION FOR MOTION PREDICTION

(71) Applicant: Waymo LLC, Mountain View, CA (US)

(72) Inventors: Yin Zhou, San Jose, CA (US); Jingwei Ji, Sunnyvale, CA (US); Zhenpei Yang, Sunnyvale, CA (US); Nathan Paul Harada, San Francisco, CA (US); Kan Chen, Sunnyvale, CA (US); Rami Al-Rfou, Menlo Park, CA (US)

(21) Appl. No.: 18/950,830

(22) Filed: Nov. 18, 2024

Related U.S. Application Data
(60) Provisional application No. 63/600,587, filed on Nov. 17, 2023.

(51) Int. Cl. G06V 10/82; B60W 60/00; G06V 10/80

(52) U.S. Cl. CPC G06V 10/82; B60W 60/00274; G06V 10/811; B60W 2420/408; B60W 2554/4045; B60W 2555/60; B60W 2556/10; B60W 2556/35

(57) ABSTRACT

Methods, systems, and apparatus for predicting future trajectories of agents in an environment. In one aspect, a system comprises one or more computers configured to receive sensor data of an environment having one or more agents. The system decomposes the sensor data into a plurality of scene elements in the environment, and the system generates multiple tokens including a respective token for each respective scene element of the multiple scene elements in the environment. The system processes the multiple tokens using a decoder model to generate a respective predicted trajectory for the one or more agents in the environment.

### CROSS-REFERENCE TO RELATED APPLICATION

This application claims the benefit of U.S. Provisional Application No. 63/600,587, filed on Nov. 17, 2023. The disclosure of these prior applications is considered part of and is incorporated by reference in the disclosure of this application.

### BACKGROUND

This specification relates to predicting the motion of agents in an environment.

The environment may be a real-world environment, and the agents may be, e.g., vehicle, pedestrians, or cyclists in the environment. Predicting the motion of objects is a task required for motion planning, e.g., by an autonomous vehicle.

Autonomous vehicles include self-driving cars, boats, and aircraft.

### BRIEF DESCRIPTION OF THE DRAWINGS

FIG. 1 is a block diagram of an example system.

FIG. 2 is a block diagram of an example trajectory prediction neural network.

FIG. 3 is a block diagram of an example scene tokenization system.

FIG. 4 is a diagram of decomposed scene element outputs.

FIG. 5 is a diagram of an example scene element feature encoding system.

FIG. 6 is a block diagram of an example scene encoder.

FIG. 7 is a flow diagram of an example process for generating trajectory predictions for one or more agents.

Like reference numbers and designations in the various drawings indicate like elements.

### DETAILED DESCRIPTION

This specification describes how a system can encode the complex features of an environment into a relatively small number of learned tokens that can then be used as input to a decoder model that can generate a trajectory prediction.

In general, this specification describes how a vehicle, e.g., an autonomous or semi-autonomous vehicle, can use a trained machine learning model, referred to in this specification as a “motion prediction system,” to generate trajectory predictions that each characterize the predicted future motion of agents in the vicinity of the vehicle in an environment.

As used in this specification, an “agent” can refer, without loss of generality, to a vehicle, bicycle, pedestrian, ship, drone, or any other moving object in an environment.

More specifically, the system receives sensor data of the environment having one or more agents. As used in this specification, the sensor data can include lidar point clouds representing the environment, camera images, or both.

The system then decomposes the sensor data into multiple scene elements in the environment. In particular, the scene elements can include ground elements, agent elements, and object elements. Based on the decomposition, the system generate tokens that include a respective token for each scene element in the environment, and the system can provide the tokens as input to the decoder model in order to generate respective trajectory predictions for each scene element in the environment.

Additionally, the system can generate the tokens using a multi-modality scene encoder configured to tokenize the scene elements and perception outputs representing sensor information of a vehicle. As used in this specification, perception outputs can include road graph data, agent motion history data, agent interaction data, and traffic light data. Thus, the system can process both the scene elements and the perception outputs using the multi-modality scene encoder to generate the tokens for trajectory prediction.

Achieving full self-driving vehicles is a complex problem because it requires anticipating the complex movements of agents in an environment. For example, pedestrians, cyclists, cars, trucks, and animals may all move in different ways.

Sensors can be used to detect and recognize these entities. For example, a system can leverage lidar sensors and cameras to collect relatively informationally dense data of the environment. However, mapping from very high-dimensional sensor inputs directly to a behavior or trajectory prediction is an extremely challenging computational problem. Some prediction systems simplify the problem by using symbolic representations of the entities. For example, a system can generate bounding box tracks that represent the movement of an agent. However, this simplification loses much of the high-fidelity information captured by sensors. For example, a bounding box representation discards information about whether it is sunny or rainy, and the existence of objects, such as puddles or other hazards, is often very relevant to being able to accurately predict agent behaviors.

Some systems can leverage the perception system of a self-driving vehicle to efficiently encode the complex perceptual information about entities in an environment using tokens. The learned tokens encapsulate important information about the environment, including semantics and geometry of objects, background material, and other agents. The learned tokens can also be used to represent other perception outputs of the environment, including agent speeds and motion history, road graph information, traffic light information. However, these learned tokens on their own may be relatively sparse, in that the tokens may not fully represent the scene or the scene context, resulting in less accurate input information used by a decoder network to generate the trajectory predictions.

To mitigate these issues, this specification describes a system that can process both perception outputs and high-dimensional sensor data to generate tokens for trajectory prediction. In particular, the system can decompose the sensor data into scene elements in the environment, including ground elements, agent elements, and object elements. The system can generate multiple tokens each representing respective scene elements, and the system can process the tokens representing the respective scene elements along with tokens representing the perception outputs. That is, the system can encode both the scene elements and the perception outputs into a relatively small number of tokens used for trajectory prediction represent a multi-modal collection of input information, which are further used by the decoder network to generate trajectory predictions. Additionally, the system can generate the tokens by further encoding image features and geometry features of each element in the environment, further increasing the accuracy of generating the trajectory predictions

Importantly, the relatively small set of tokens, e.g., tens or hundreds of tokens, efficiently represents very complex information about the environment in a way that the decoder can use to generate the trajectory predictions. Thus, the system is able to leverage both perception outputs and high-dimensional sensor for increased accuracy in resulting trajectory predictions. Additionally, because the system can efficiently encode the high-dimensional sensor data into recognizable tokens, the system can refrain from specifically training the trajectory prediction neural network on processing the sensor data, resulting in increased training efficiency.

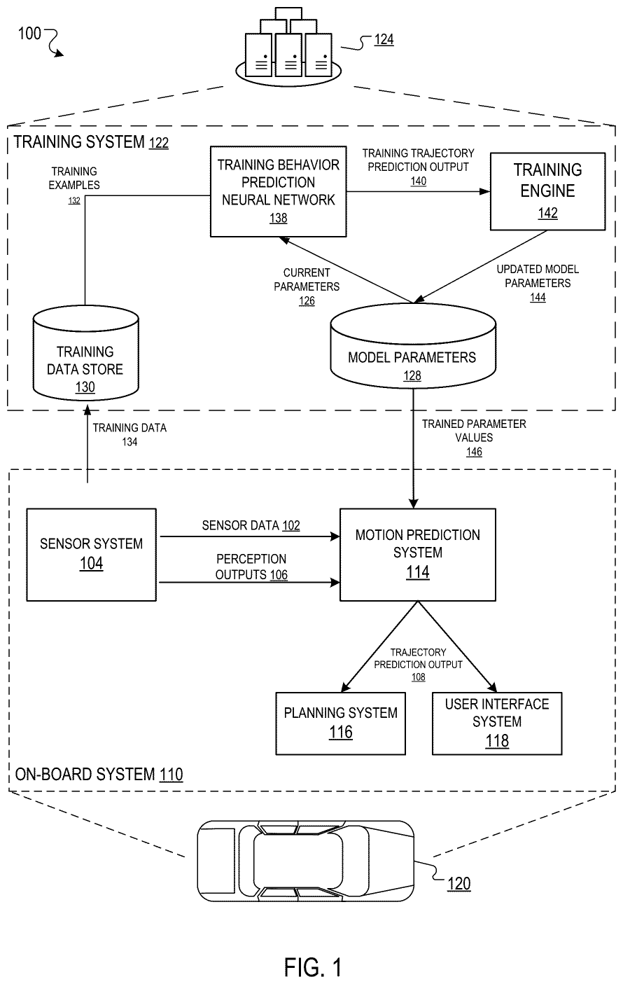

FIG. 1 is a diagram of an example system 100. The system 100 includes an on-board system 110 and a training system 122.

The on-board system 110 is located on-board a vehicle 120. The vehicle 120 in FIG. 1 is illustrated as an automobile, but the on-board system 110 can be located on-board any appropriate vehicle type.

In some cases, the vehicle 120 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 120 can autonomously apply the brakes if a prediction indicates that a human driver is about to collide with another vehicle. As another example, the vehicle 120 can have an advanced driver assistance system (ADAS) that assists a human driver of the vehicle 120 in driving the vehicle 120 by detecting potentially unsafe situations and alerting the human driver or otherwise responding to the unsafe situation. As a particular example, the vehicle 120 can alert the driver of the vehicle 120 or take an autonomous driving action when an obstacle is detected, when the vehicle departs from a driving lane, or when an object is detected in a blind spot of the human driver.

The on-board system 110 includes a sensor system 104 which enables the on-board system 110 to “see” the environment in the vicinity of the vehicle 120. More specifically, the sensor system 104 includes one or more sensors, some of which are configured to receive reflections of electromagnetic radiation from the environment in the vicinity of the vehicle 120. For example, the sensor system 104 can include one or more laser sensors (e.g., lidar laser sensors) that are configured to detect reflections of laser light. That is, the lidar laser sensors can collect data in the form of point clouds, where each point of the point cloud represents a feature of the environment at a particular time point. As another example, the sensor system 104 can include one or more radar sensors that are configured to detect reflections of radio waves. As another example, the sensor system 104 can include one or more camera sensors that are configured to detect reflections of visible light. That is, a camera sensor can capture one or more camera images at different time points.

The sensor system 104 continually (i.e., at each of multiple time points) captures raw sensor data, which can indicate the directions, intensities, and distances travelled by reflected radiation. For example, a sensor in the sensor system 104 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

The on-board system 110 can process the raw sensor data to generate sensor data 102 and perception outputs 106 that characterize a scene in an environment over multiple time points. Generally, the “scene” is an area of the environment that includes the area within a threshold distance of the autonomous vehicle or the area that is within range of at least one sensor of the vehicle.

Generally, the sensor data 102 and the perception outputs 106 include multiple modalities of features that describe the scene in the environment. A modality, as used in this specification, refers to a feature that provides a particular type of information about the environment. Thus, different modalities provide different types of information about the environment.

The sensor data 102 can capture features of the environment at different time points (e.g., history frames) using one or more modalities. In particular, the modalities can include (i) features from a lidar point cloud modality that represents information about the environment based on point clouds from a lidar sensor, (ii) features from a camera image modality that represents information about the environment based on camera images from a camera sensor, or both.

The perception outputs 106 can include features from two or more of the following modalities: a traffic light state modality that provides information about a traffic light state of traffic lights in the environment, a road graph data modality that provides static information about the roadways in the environment, an agent history modality that provides information about the current and previous positions of agents in the environment, and an agent interaction modality that provides information about interactions between agents in the environment.

At any given time point, the on-board system 110 can process the sensor data 102 and the perception outputs 106 using a trajectory prediction neural network 114 to predict the trajectories of agents (e.g., pedestrians, bicyclists, other vehicles, and the like) in the environment in the vicinity of the vehicle 120.

In particular, the on-board system 110 can generate a respective trajectory prediction output 108 for each of one or more agents in the scene at the given time point. The trajectory prediction output 108 for an agent predicts the future trajectory of the agent after the current time point.

The future trajectory for an agent is a sequence that includes a respective agent state for the agent for each of a plurality of future time points, i.e., time points that are after the current time point. Each agent state identifies at least a waypoint location for the corresponding time point, i.e., identifies a location of the agent at the corresponding time point. In some implementations, each agent state also includes other information about the state of the agent at the corresponding time point, e.g., the predicted heading of the agent at the corresponding time point. The heading of an agent refers to the direction of travel of the agent and can be expressed as angular data (e.g., in the range 0 degrees to 360 degrees) which is defined relative to a given frame of reference in the environment (e.g., a North-South-East-West frame of reference).

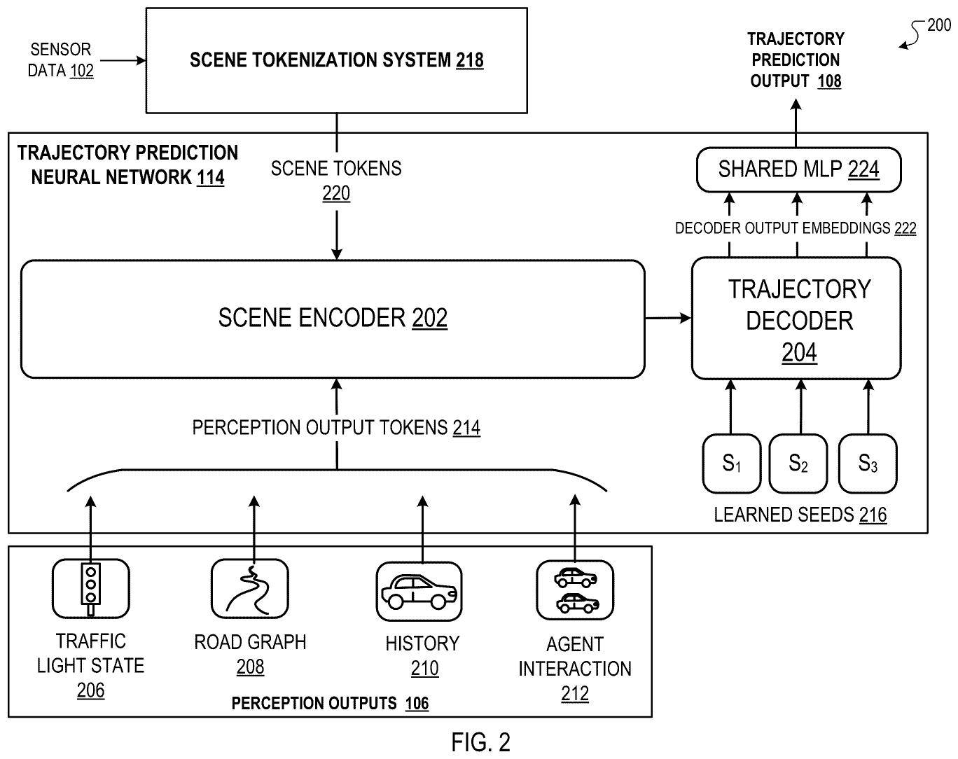

The processing performed by the trajectory prediction neural network 114 to generate the trajectory prediction output 108 is described in further detail below with reference to FIGS. 2, 6, and 7.

The on-board system 110 can provide the trajectory prediction output 108 generated by the trajectory prediction neural network 114 to a planning system 116, a user interface system 118, or both.

When the planning system 116 receives the trajectory prediction output 108, the planning system 116 can use the trajectory prediction output 108 to make fully-autonomous or partly-autonomous driving decisions. For example, the planning system 116 can generate a fully-autonomous plan to navigate the vehicle 120 to avoid a collision with another agent by changing the future trajectory of the vehicle 120 to avoid the predicted future trajectory of the agent. In a particular example, the on-board system 110 may provide the planning system 116 with trajectory prediction output 108 indicating that another vehicle which is attempting to merge onto a roadway being travelled by the vehicle 120 is unlikely to yield to the vehicle 120. In this example, the planning system 116 can generate fully-autonomous control outputs to apply the brakes of the vehicle 120 to avoid a collision with the merging vehicle. The fully-autonomous or partly-autonomous driving decisions generated by the planning system 116 can be implemented by a control system of the vehicle 120. For example, in response to receiving a fully-autonomous driving decision generated by the planning system 116 which indicates that the brakes of the vehicle should be applied, the control system may transmit an electronic signal to a braking control unit of the vehicle. In response to receiving the electronic signal, the braking control unit can mechanically apply the brakes of the vehicle.

When the user interface system 118 receives the trajectory prediction output 108, the user interface system 118 can use the trajectory prediction output 108 to present information to the driver of the vehicle 120 to assist the driver in operating the vehicle 120 safely. The user interface system 118 can present information to the driver of the vehicle 120 by any appropriate means, for example, by an audio message transmitted through a speaker system of the vehicle 120 or by alerts displayed on a visual display system in the vehicle (e.g., an LCD display on the dashboard of the vehicle 120). In a particular example, the on-board system 110 may provide the user interface system 118 with trajectory prediction output 108 indicating that another vehicle which is attempting to merge onto a roadway being travelled by the vehicle 120 is unlikely to yield to the vehicle 120. In this example, the user interface system 118 can present an alert message to the driver of the vehicle 120 with Instructions to adjust the trajectory of the vehicle 120 to avoid a collision with the merging vehicle.

Prior to the on-board system 110 using the trajectory prediction neural network 114 to make predictions, a training system 122 can determine trained parameter values of the trajectory prediction neural network 114 by training the neural network 114 on training data.

The training system 122 is typically hosted within a data center 124, which can be a distributed computing system having hundreds or thousands of computers in one or more locations.

The training system 122 can store the training data 134 in a training data store 130.

The training system 122 includes a training trajectory prediction neural network 138 that is configured to generate behavior prediction data from input scene context data. The training behavior prediction neural network 238 generally has (at least partially) the same architecture as the on-board trajectory prediction neural network 114,

The training trajectory prediction neural network 138 is configured to obtain training examples 132 from the training data store 130. The training examples 132 can be a subset of the training data 134. The training examples 132 in the training data store 130 may be obtained from real or simulated driving data logs.

The training examples 132 can include data from multiple different modalities. In some cases the context data includes raw sensor data generated by one or more sensors, e.g., a camera sensor, a lidar sensor, or both. In other cases, the context data includes data that has been generated from the outputs of an object detector that processes the raw sensor data.

The training trajectory prediction neural network 138 processes the training examples 132 to generate a training trajectory prediction output 140.

The training engine 142 then trains the training trajectory prediction neural network 138 on the training examples 132 to generate updated model parameter values 144 by minimizing a loss function based on ground truth trajectories for each agent.

Once the parameter values of the training trajectory prediction neural network 138 have been fully trained, the training system 122 can send the trained parameter values 146 to the trajectory prediction neural network 114, e.g., through a wired or wireless connection.

While this specification describes that the trajectory prediction output 108 is generated on-board an autonomous vehicle, more generally, the described techniques can be implemented on any system of one or more computers that receives images of scenes in an environment. That is, once the training system 122 has trained the trajectory prediction neural network 114, the trained neural network can be used by any system of one or more computers.

As one example, the trajectory prediction output 108 can be generated on-board a different type of agent that has sensors and that interacts with objects as it navigates through an environment. For example, the trajectory prediction output 108 can be generated by one or more computers embedded within a robot or other agent.

As another example, the trajectory prediction output 108 can be generated by one or more computers that are remote from the agent and that receive images captured by one or more camera sensors of the agent. In some of these examples, the one or more computers can use the trajectory prediction output 108 to generate control decisions for controlling the agent and then provide the control decisions to the agent for execution by the agent.

FIG. 2 shows a block diagram of an example trajectory prediction neural network 114 when being used to predict a future trajectory for agents in a scene using both sensor data 102 and perception outputs 106.

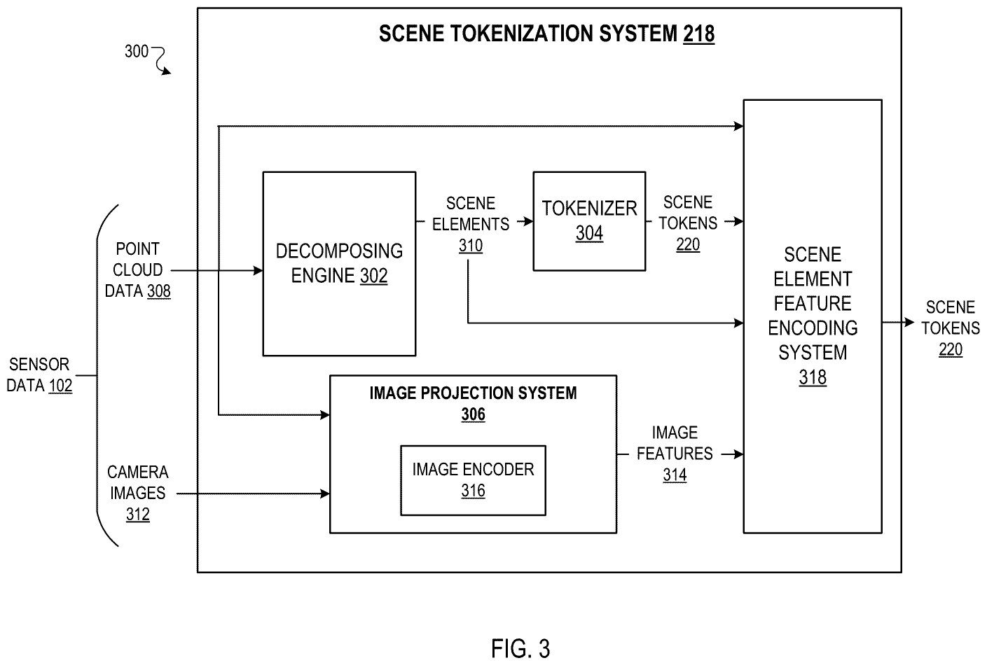

The system uses the trajectory prediction neural network 114 to generate a trajectory prediction output 108 by processing tokens representing both sensor data 102 and perception outputs 106. The trajectory prediction neural network 114 includes a scene encoder 202, a trajectory decoder 204, and a shared multilayer perceptron (MLP) 224. Additionally, the system uses a scene tokenization system 218 to generate scene tokens representing the sensor data 102, as described in further detail below with reference to FIGS. 3, 4, and 5.

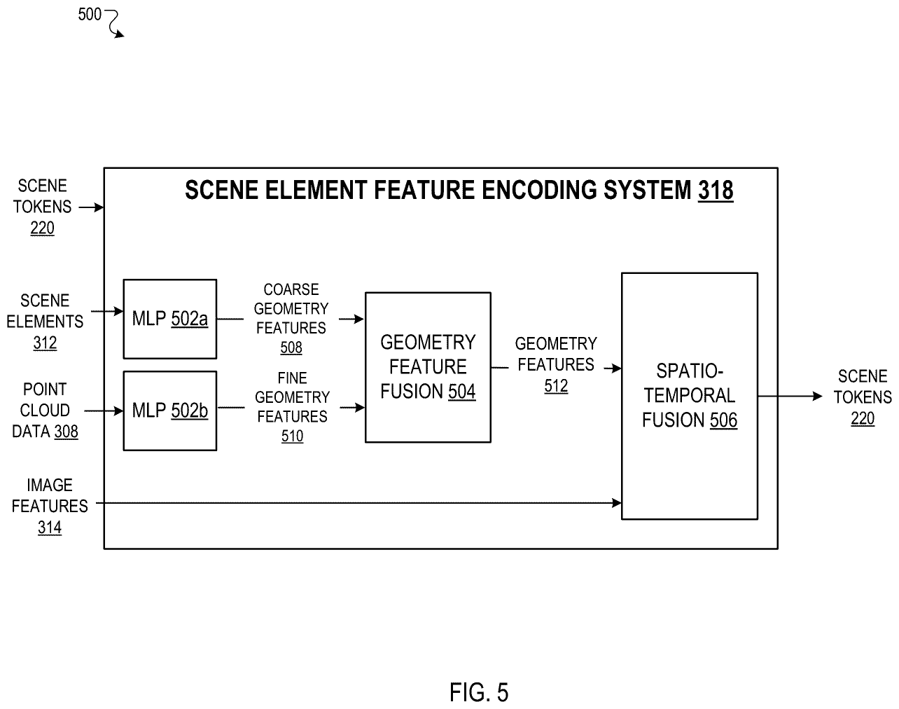

That is, the trajectory prediction neural network 114 obtains the scene tokens 220 representing the sensor data 102 and perception output tokens 214 representing the sensor data 102. In particular, the scene tokens 220 represent intrinsic information about the environment, such as object semantics, object geometry, and scene context, and the perception output tokens 214 represent multiple modalities of perception data. The scene tokens 220 can also include encoded image features and geometry features of scene elements in the environment, as described in further detail with reference to FIGS. 3 and 5.

By using both the scene tokens 220 and the perception output tokens 214 to generate the trajectory prediction output 108, the system can more accurately generate trajectory predictions with increased flexibility and scalability in handling multiple features of an environment. For example, in the case of unideal road conditions, such as a puddles, or possible errors in perception output representations, the system can preserve robustness in generating trajectory predictions for one or more agents. Additionally, by encoding geometry features and image features as part of the scene tokens 220, the system is able to more accurately represent both coarse and fine elements of the environment.

The sensor data 102 characterizes a scene in an environment at multiple time points. In particular, the sensor data 102 can include (i) camera images captured by a camera sensor at different history frames and (ii) point cloud data captured by lidar sensors at different history frames. The scene tokenization system 218 can process the sensor data 102 to generate the scene tokens 220 by decomposing and tokenizing features of the sensor data 102, as described in further detail below with reference to FIGS. 3, 4, and 5.

The perception outputs 106 include multiple modalities of data. In the example of FIG. 2, the multiple modalities include traffic light state data 206, road graph data 208, agent history data 210, and agent interaction data 212.

The traffic light state data 206 characterizes at least respective current states of one or more traffic signals in the scene. The state of a traffic light at a given time point represents the indication being provided by the traffic signal at the given time point, e.g., whether the traffic light is green, yellow, red, flashing, and so on.

The road graph 208 includes road graph context data characterizing road features in the scene, e.g., driving lanes, crosswalks, and so on.

The history 210 includes agent history data characterizing current and previous states of each of the one or more agents. The agent interaction 212 includes context agent history context data characterizing states (e.g., current and previous states) of one or more context agents that are in proximity to a target agent.

The data for each modality that is received by the neural network 114 is represented as perception output tokens 214. For example, the system can process the perception outputs 106 to generate the perception output tokens 214 using a neural network (e.g., an encoder neural network) configured to generate tokens by processing different modalities of data.

The trajectory prediction neural network 114 processes the perception output tokens 214 and the scene tokens 220 using the scene encoder 202 to generate a combined token representation, as described in further detail below with reference to FIG. 2.

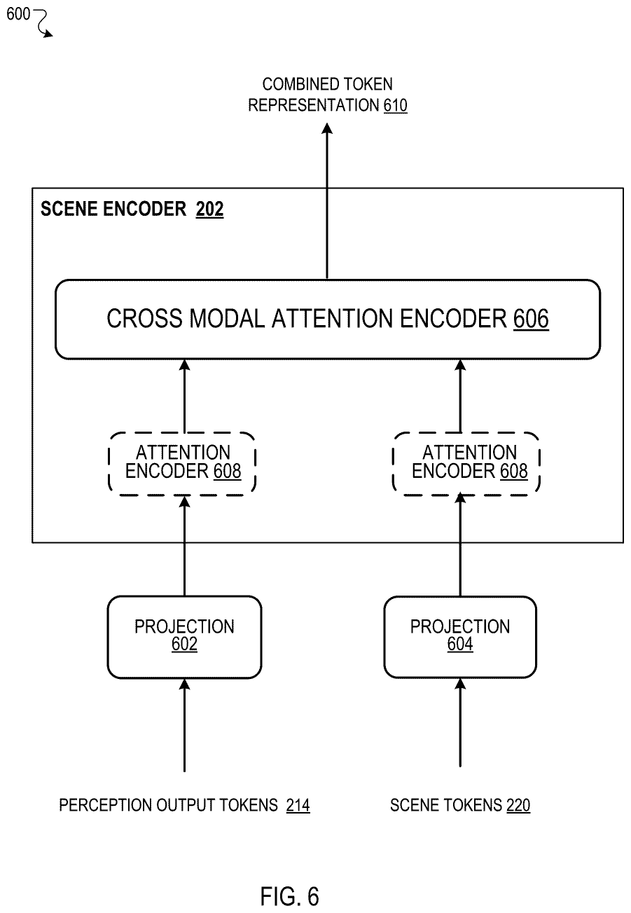

Generally, the scene encoder 202 can have any appropriate neural network architecture that allows the encoder 202 to fuse the two token representations (the scene tokens 220 and the perception output tokens 214). That is, the encoder 202 can “fuse” the token representations by combining (e.g., concatenating) the scene tokens 220 and the perception output tokens 214 according to a particular algorithm or technique. In particular, the encoder 202 can be a self-attention neural network that includes multiple self-attention layers. The system can initialize the combined token representation (e.g., by generating a number N of random tokens or using the already-generated tokens 220 or tokens 214 as an initial token representation), and the system can use the multiple self-attention layers to update the combined token representation by applying self-attention over the two original token representations and one or more layers that update the combined token representations by cross-attending over the scene tokens 220 and the perception output tokens 214, as described in further detail below with reference to FIG. 6.

The trajectory prediction neural network 114 then processes the combined token representation using the trajectory decoder 204 and the shared MLP 224 to generate a trajectory prediction output 108 for each agent that predicts a future trajectory after the current time point.

Generally, the trajectory decoder 204 can have any appropriate neural network architecture that allows the decoder 204 to map the combined token representation to decoder outputs embeddings 222 for one or more agents. For example, the decoder neural network 204 can be a Transformer, a convolutional neural network, a vision Transformer, or a recurrent neural network.

Each decoder output embedding 222 can define a probability distribution over possible future trajectories of a particular agent after the current time point. For example, the trajectory prediction neural network can perform batching to generate multiple decoder output embeddings 222 corresponding to multiple agents in parallel.

In some examples, the trajectory prediction neural network 114 can obtain learned seeds 216 and process the learned seeds 216 along with the combined token representation using the trajectory decoder 204. The learned seeds 216 can be learned initial queries that are learned during the training of the trajectory prediction neural network 114.

In particular, the trajectory decoder 204 can be a self-attention neural network that includes one or more layers that update the learned seeds 216 by applying self-attention over the learned seeds 216 and one or more layers that update the learned seeds 216 by cross-attending over the combined token representation.

The shared MLP 224 can then process the decoder output embeddings 222 to generate the trajectory prediction output 108. In particular, the shared MLP 224 can map each of the decoder output embeddings to a single trajectory for each agent, where the trajectory prediction output 108 represents the trajectory prediction for each agent of multiple agents in the environment.

During training, the trajectory prediction neural network 114 can be trained to process training scene context data to generate a training trajectory prediction output. Thus, the loss trains trajectory prediction neural network 114 to generate outputs by minimizing a loss function based on ground truth trajectories for each agent. That is, the system 100 can jointly train the encoder 202 and the decoder 204 on a loss function. For example, the loss function can include a classification loss and a regression loss, as shown by Equation 1:

$$L = max log Pr ( \hat{ι} \vert Y ) + log Pr ( G \vert {T}_{\hat{ι}} ) \qquad ( 1 )$$

where maxlogPr(î|Y) is the classification loss over an index î|of a Gaussian distribution T_{î} given an embedding Y and log Pr (G|T_{î}) is the regression loss over a ground truth trajectory G given the Gaussian distribution T_{î}. In particular, the classification loss measures the logarithm of the probability assigned to the mode of the Gaussian distribution that is closest to the ground truth trajectory, and the regression loss measures the log of the probability assigned to the ground truth trajectory by the mode that is closest to the ground truth trajectory.

FIG. 3 is a block diagram of an example scene tokenization system when being used to generate scene tokens 220 by processing sensor data 102.

The system uses the scene tokenization system 218 to generate scene tokens 220 for trajectory prediction of agents in an environment. In particular, the scene tokenization system 218 can encode relatively high dimensional data into tokens recognizable by a trajectory prediction neural network, allowing for more accurate predictions due to a larger extent of encoded data representing the environment.

The scene tokenization system 218 processes the sensor data 102 using a decomposing engine 302, a tokenizer 304, an image projection system 306, and a scene element feature encoding system 318. The sensor data 102 includes point cloud data 308 representing multiple point clouds at multiple history frames of the environment and camera images 312 representing images captured by a camera at multiple history frames of the environment.

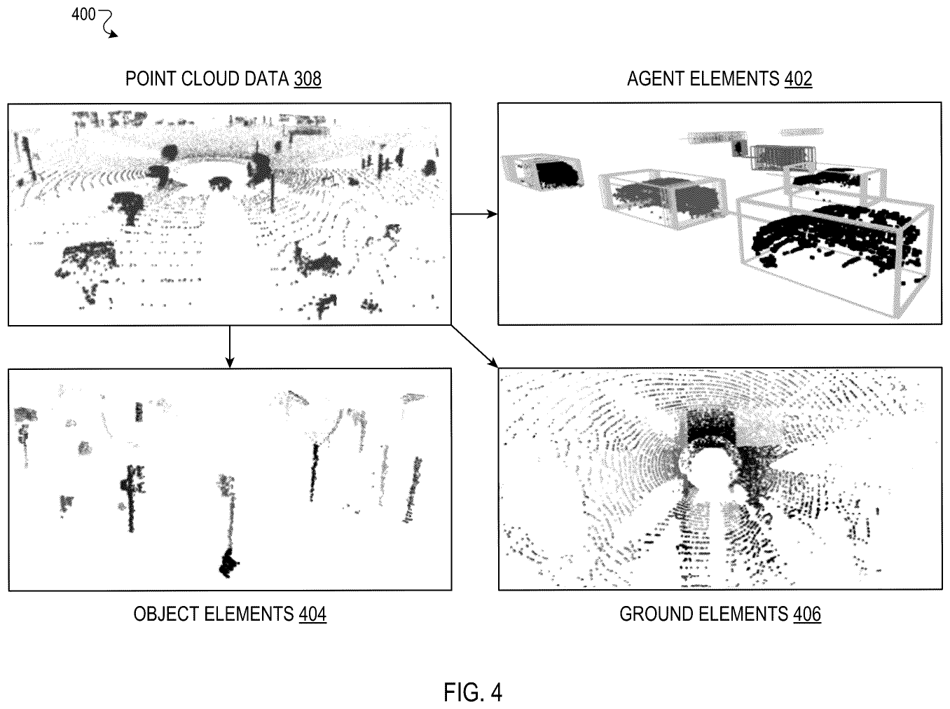

The decomposing engine 302 is configured to decompose the point cloud data 308 into a set of scene elements 310. The scene elements 310 are embeddings that represent ground elements, agent elements, and object elements of the environment, as described in further detail below with reference to FIG. 4. In particular, the decomposing engine 302 is configured to perform ground-plane fitting and connected component analysis for decomposing the point cloud data 308, and, in some examples, the decomposing engine 302 is configured to collapse scene elements that appear over multiple history frames into a single scene element, as described in further detail below with reference to FIG. 4.

The tokenizer 304 is configured to process the scene elements 310 to generate the scene tokens 220. The tokenizer 304 can have any appropriate architecture configured to generate tokens by processing corresponding embeddings. The system uses the tokenizer 304 to assign a token identifier to each point of a point cloud based on the scene elements 310. The points within the same scene element 310 have the same token identifier.

In particular, the system can use the tokenizer 304 to generate a corresponding token for each agent element using a neural network, a corresponding token for each ground element using a different neural network, and a corresponding token for each object element, as described in further detail below with reference to FIG. 4.

The image projection system 306 is configured to process the camera images 312 and the point cloud data 308 to generate image features 314. In particular, the image projection system 306 extracts feature maps from the camera images 312 and maps each element of the feature map to a point of the corresponding point cloud of the point cloud data 308.

In particular, the image projection system 306 includes a pre-trained image encoder 316 configured to generate a feature map by processing an image. The image encoder 316 can have any appropriate neural network architecture (e.g., ViT-H, VQ-GAN, or CLIP) that allows the encoder 316 to extract a feature map from each of the camera images 312. The feature map includes multiple image feature vectors each representing elements of the image.

The system 306 then, at each history frame, maps an image feature vector of the feature map to a point of a corresponding point cloud at the same time point to generate the image features 314. The image features 314 then include a respective image feature for each point of each point cloud of the point cloud data 308. In some examples, the system can use sensor calibration data to perform the mapping between feature vectors and points of the point clouds.

In some examples, the system can also generate a tensor that indicates a history frame identifier and a scene element identifier for each point of a point cloud of the point cloud data 308. In this case, the system can map each image feature 314 to a corresponding vector based on the scene element identifier.

The scene element feature encoding system 318 is then configured to process the scene tokens 220, the point cloud data 308, the scene elements 310, and the image features 314 to encode the scene tokens 220 with geometry features and image features 314, as described in further detail below with reference to FIG. 5.

FIG. 4 is a diagram of decomposed scene element outputs when generated by decomposing engine 302 using point cloud data 308.

Decomposing each of the scene elements 310 allows for a more accurate token representation of the environment. For each point cloud at a particular history frame of the point cloud data 308, the decomposing engine 302 decomposes the point cloud into multiple distinct types of scene elements 310. In particular, the decomposing engine 302 defines bounding boxes for each of the scene elements 310 by assigning each point to an element identifier.

The types of scene elements 310 and element identifiers include agent elements 402, object elements 404, and ground elements 406, where the total number of scene elements is the sum of the agent elements 402, the object elements 404, and the ground elements 406, as shown by Equation 2:

$${N}_{e l e m} = {N}_{elements}^{g n d} + {N}_{elements}^{agent} + {N}_{e l e m e n t s}^{object} \qquad ( 2 )$$

The agent elements 402 represent one or more agents in the environment. In particular, each agent elements 402 includes points of the point cloud within a bounding box of an identified agent. The agent elements 402 can be closed-set, in that each agent element 402 representing an agent can fall into one or more defined categories (e.g., pedestrian, cyclist, etc.).

The object elements 404 represent objects that are not included as part of the agent elements 402. For example, the object elements 402 can include traffic signs, traffic lights, or environmental obstacles, such as puddles. In particular, the engine 302 extracts the object elements 402 by removing agent elements 402 and ground elements 406 from the point cloud and performing connected component analysis to group points into object elements 404.

The ground elements 406 represent the ground area. In particular, each ground element 406 can be defined as segments corresponding to the ground area. The engine 302 can use any particular algorithm to segment the ground elements 406, such as a point segmentation model configured to process point clouds or a random sample consensus (RANSAC) algorithm. In some examples, the engine 302 can divide the ground area into the ground elements 406 as one or more tiles.

In some examples, for more efficient processing of the scene elements 310, the system can collapse the scene elements 310 that appear over multiple history frames into a single scene element 310. In particular, the system can perform a downsampling process using the point cloud data 308 to collapse multiple similar scene elements 310 into a single scene element 310. For example, the system can use a Kalman filter for the downsampling process.

In some examples, the system can perform a downsampling process for static elements (e.g., ground elements 406) and a different downsampling process for dynamic elements (e.g., the agent elements 402 and the object elements 404). For example, the system can perform a single decomposition after combining the ground elements 406, and the system can uniformly subsample from the single decomposition a fixed number of ground elements N^{gnd}ₑₗₑₘₑₙₜₛ. The system can then subsample a fixed number of agent elements N^{agent}ₑₗₑₘₑₙₜₛ and a fixed number of object elements N^{object}ₑₗₑₘₑₙₜₛ.

The system can then provide the scene elements 310 to the tokenizer 304.

FIG. 5 is a diagram of an example scene element feature encoding system when being used to encode scene tokens 220 with image features and geometry features of a scene.

The system encodes the scene tokens 220 with image features 314 and geometry features of the scene by processing the scene elements 310 and the point cloud data 308 to generate the geometry features 512.

The system 318 includes MLPs 502a and 502b, a geometry feature fusion block 504, and a spatio-temporal fusion block 506. Each of the MLPs is configured to generate a type of geometry features (e.g., coarse geometry features 508 or fine geometry features 510). The geometry feature fusion block 504 is configured to fuse the coarse geometry features 508 and the fine geometry features 510 to generate the geometry features 512. The spatio-temporal fusion block 506 is configured to fuse the geometry features 512 and the image features 514 to generate the scene tokens 220 for each type of scene element.

The system 318 uses the MLP 506a to generate the coarse geometry features 508 by processing the scene elements 310. The coarse geometry features 508 represent high-dimensional features of the environment based on the scene elements 310. In particular, the coarse geometry features 508 include agent geometry features derived from the agent elements 402, object geometry features derived from the object elements 404, and ground geometry features derived from the ground elements 406.

For the agent elements 402, the system 318 uses the MLP 506a to extract the agent geometry features such as agent positions, sizes, and velocities from the agent elements 402. In some examples, the system 318 can use perception data to extract the agent geometry features.

For the object elements 404, the system 318 uses the MLP 506a to extract the object geometry features based on the bounding box for each particular object. In particular, the system 318 computes a tight bounding box that includes each point associated with the particular object in the corresponding point cloud, and the system 318 uses the MLP 506a to extract the object features, including the box center, box size, and the heading of the object.

For the ground elements 406, the system 318 uses the MLP 506a to extract the ground geometry features based on the bounding box for each ground region (e.g., each tile corresponding to the ground region). In particular, the system 318 uses the MLP 506a to extract a box center for each of the tiles corresponding to the ground region.

The system 318 uses the MLP 506b to generate the fine geometry features 510 by processing the point cloud data 308. The MLP 506b maps the coordinates of each point of the point clouds of the point cloud data 308 onto a higher dimensional space, and the MLP 506b groups the mapped features according to the corresponding token identifier and history frame identifier.

The system 318 fuses the coarse geometry features 508 and the fine geometry features 510 at the geometry feature fusion block 504 to generate the geometry features 512. In particular, the system combines the coarse geometry features 508 and the fine geometry features 510 by pooling mapped features based on the corresponding token identifier and history frame identifier, as shown by Equation 3:

$${F}_{geo}^{i} = poolbyindex ( {MLP}_{f} ( {P}_{xyz} ) , {P}_{ind} ) [ i , : , : ] + {MLP}_{c} ( B ) [ i , : , : ] \qquad ( 3 )$$

where the function poolbyindex performs pooling of the pointwise mapped features based on the token identifier i, f_{geo}ⁱ represents the geometry features 512, MLP_{f} is MLP 506b, P_{xyz} represents the point cloud data 308, P_{ind} represents an embedding that indicates the token identifier and the corresponding history frame identifier, MLP_{c} is MLP 506a, and B represents the scene elements 312. In some examples, the system 318 can also fuse temporal features with the coarse geometry features 508 and the fine geometry features 510 to generate the geometry features 512. The temporal features can be a temporal embedding that corresponds to a particular number of history frames.

The system 318 then fuses the geometry features 512 and the image features 314 at the spatio-temporal fusion 506 to encode the scene tokens 220 with scene feature information. In particular, the system combines the geometry features 512 and the image features 314 to generate a scene feature embedding, and the system performs axial attention across the scene feature embedding for encoding the scene tokens 220. The system performs axial attention across the temporal axis and the element axis of the scene feature embedding.

The system 318 can then provide the scene tokens 220 as input to the trajectory prediction neural network 114.

FIG. 6 is a block diagram of an example scene encoder 202 when being used to fuse scene tokens 220 and perception output tokens 214.

The system is configured to generate a projection 602 for each of the tokens and to process the projections 602 using the scene encoder 202 to generate a combined token representation 610. The combined token representation 610 represents a combined representation of the tokens 214 and the tokens 220.

The system generates a projection 602 for each of the different modalities of the perception output tokens 214 and the scene tokens 220. In particular, the system linearly projects each of tokens such that each of the tokens have a same dimensionality. The system then provides the projection 602 of the perceptual output tokens 214 and the projection 604 of the scene tokens 220 to the scene encoder 202.

The scene encoder 202 is configured to fuse the projections of the perception output tokens 214 and the scene tokens 220 to generate a combined token representation 610. In particular, as part of generating the combined token representation 610, the trajectory prediction neural network uses the scene encoder 202 to generate a combined token representation by fusing the projection 602 and the projection 604.

The trajectory prediction neural network 114 then processes the combined token representation 610 using the trajectory decoder 204 and the shared MLP 224 to generate the trajectory prediction output 108.

The scene encoder includes a cross modal attention encoder 606 with multiple self-attention layers.

The cross modal attention encoder 606 can be a single self-attention encoder that takes the projections as input to generate the combined token representation 610. In some examples, the scene encoder 202 further includes respective attention encoders 608 for each projection.

The cross modal attention encoder 606 can perform early fusion or hierarchical fusion of the projections. For example, the cross modal attention encoder 606 can be a multi-axis attention encoder or a factorized attention encoder that performs early fusion. That is, the cross modal attention encoder 606 can include any combination of: one or more multi-axis encoder blocks, one or more multi-axis latent query encoder blocks, one or more temporal cross-modal attention layer blocks that self-attend over the projections along the temporal dimension, or one or more temporal spatial cross-modal attention blocks corresponding to each of the projections along the spatial dimension.

In some other examples, the scene encoder 202 can perform hierarchical fusion by using respective attention encoders 608 to process the projections. That is, the system processes each projection using a corresponding encoder 608 that applies self-attention to the projections of that modality. The scene encoder 202 then uses the cross modal attention encoder 606 to generate the combined token representation 610.

The trajectory prediction neural network then processes the combined token representation 610 using a trajectory decoder and a shared MLP to generate the trajectory prediction output, as described above.

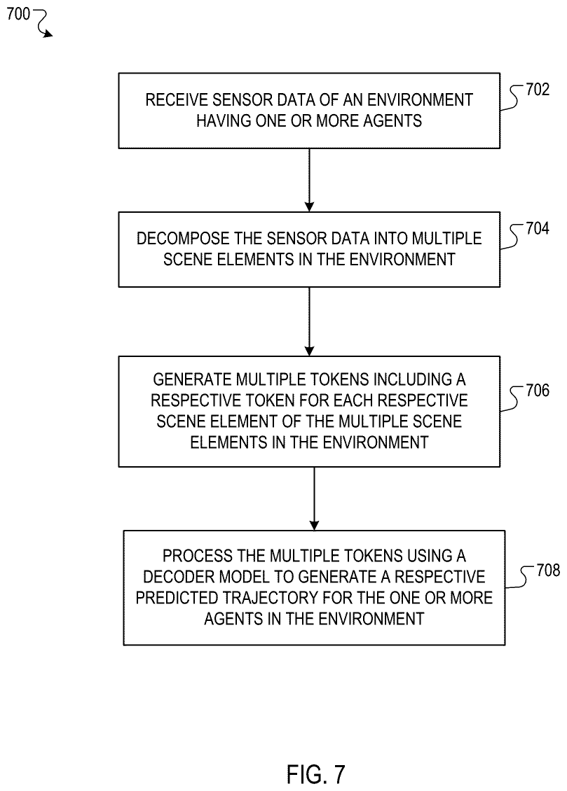

FIG. 7 is a flow diagram of an example process for generating trajectory predictions for one or more agents. For convenience, the process 700 will be described as being performed by a system of one or more computers located in one or more locations. For example, a system, e.g., the system 100 of FIG. 1, appropriately programmed in accordance with this specification, can perform the process 700.

The system receives sensor data of an environment having one or more agents (702). The sensor data includes point cloud data representing multiple point clouds each at a different time point (e.g., history frame) and camera images representing images each at different history frames.

Additionally, the system receives perception outputs 106 representing the environment. The perception outputs 106 can include road graph data representing one or more features of a road graph of the environment, agent history data representing an agent velocity or motion history for each agent, traffic light data representing a traffic light status for a traffic light in the environment, or agent interaction data representing one or more motion-based characteristics of an agent in the environment.

The system decomposes the sensor data into multiple scene elements in the environment (704). In particular, the system can decompose the sensor data into ground elements, agent elements and object elements by distinguishing agent and objects from a ground region in the environment.

In some examples, the system can collapse the scene elements by downsampling the point cloud data. For example, the system can downsample the point cloud data by performing a first downsampling process for ground elements and a different second downsampling process for agent elements and object elements.

The system generates multiple tokens including a respective token for each respective scene element of the multiple scene elements in the environment (706). The system generates the multiple tokens by processing the scene elements using a multi-modality scene encoder configured to tokenize both the scene tokens generated from the scene elements and perception output tokens generated from the perception outputs. In particular, the scene encoder is configured to apply operations of multiple self-attention layers to fuse information extracted from the scene tokens and the perception output tokens.

To generate the scene tokens, the system generates a token for each scene element by encoding image features and geometry features of each element in the environment. In particular, the system generates different tokens for each type of scene element using the image features and geometry features. That is, the system generates a token for an agent element, another token for a ground elements, and another token for an object element. In particular, the system can generate a token for the agent element using a first model and the token for the ground element using a second model.

The system processes the multiple tokens using a decoder model to generate a respective predicted trajectory for the one or more agents in the environment (708).

This specification uses the term “configured” in connection with systems and computer program components. For a system of one or more computers to be configured to perform particular operations or actions means that the system has installed on IT software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, subprograms, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magnetooptical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving sensor data of an environment having one or more agents;
decomposing the sensor data into a plurality of scene elements in the environment;
generating a plurality of tokens including a respective token for each respective scene element of the plurality of scene elements in the environment; and
processing the plurality of tokens using a decoder model to generate a respective predicted trajectory for the one or more agents in the environment.

2. The method of claim 1, wherein decomposing the sensor data into the plurality of scene elements comprises distinguishing an agent in the environment from a ground region in the environment, and wherein generating the plurality of tokens comprises generating a first token for the agent and a different second token for the ground region.

3. The method of claim 2, wherein generating the first token comprises using a first model and wherein generating the second token comprises using a different second model.

4. The method of claim 3, wherein decomposing the sensor data into the plurality of scene elements comprises generating a different third token for an object in the environment.

5. The method of claim 1, wherein generating a token for a scene element in the environment comprises encoding image features and geometry features of an entity in the environment.

6. The method of claim 1, wherein generating the plurality of tokens is performed by a multi-modality scene encoder configured to tokenize scene elements in a scene as well as perception outputs representing sensor information of a vehicle.

7. The method of claim 1, wherein generating the plurality of tokens comprises applying the operations of a plurality of self-attention layers.

8. The method of claim 7, wherein the plurality of self-attention layers fuse information extracted from tokens for the scene elements and tokens generated from perception systems of a vehicle.

9. The method of claim 1, wherein the decoder model has a Transformer-based architecture.

10. The method of claim 1, wherein generating the plurality of tokens comprises generating a token representing one or more features of a road graph for the environment.

11. The method of claim 1, generating the plurality of tokens comprises generating a token representing one or more motion-based characteristics of an agent in the environment.

12. The method of claim 11, wherein the motion-based characteristics include an agent velocity or a motion history.

13. The method of claim 1, wherein generating the plurality of tokens comprises generating a token representing traffic light information for a traffic light within the environment.

14. The method of claim 1, further comprising adjusting a trajectory of a vehicle based on the predicted trajectory of the scene element in the environment.

15. The method of claim 1, wherein the sensor data represents sensor observations over a plurality of history frames.

16. The method of claim 15, further comprising collapsing scene element representations that appear over the plurality of history frames into a single scene element representation.

17. The method of claim 15, wherein collapsing the scene element representations comprises downsampling LiDAR data.

18. The method of claim 17, wherein downsampling the LiDAR data comprises performing a first downsampling process for ground scene elements and a different second downsampling process for other scene elements.

19. A system comprising one or more computers and one or more storage devices storing instructions that are operable, when executed by the one or more computers, to cause the one or more computers to perform operations comprising:
receiving sensor data of an environment having one or more agents;
decomposing the sensor data into a plurality of scene elements in the environment;
generating a plurality of tokens including a respective token for each respective scene element of the plurality of scene elements in the environment; and
processing the plurality of tokens using a decoder model to generate a respective predicted trajectory for the one or more agents in the environment.

20. One or more non-transitory computer storage media encoded with computer program instructions that when executed by a plurality of computers cause the plurality of computers to perform operations comprising:
receiving sensor data of an environment having one or more agents;
decomposing the sensor data into a plurality of scene elements in the environment;
generating a plurality of tokens including a respective token for each respective scene element of the plurality of scene elements in the environment; and
processing the plurality of tokens using a decoder model to generate a respective predicted trajectory for the one or more agents in the environment.
